(19) United States
(12) Patent Application Publication
(10) Pub. No.: US 2009/0192886 A1
(43) Pub. Date: Jul. 30, 2009

(54) Automatic online mail printing and package system at post office or place of receiver for mails which are sent from home or office via internet

(76) Inventor: Ky Van Nguyen, Castro Valley, CA (US)

Correspondence Address: KY VAN NGUYEN, APT # 5, 20200 FOREST AVE, CASTRO VALLEY, CA, 94546, US

(21) Appl. No.: 12/009,084

(22) Filed: Jan. 16, 2008

(51) Int. Cl. G06Q 30/00; G06F 15/16; G07B 17/02

(52) U.S. Cl. 705/14; 709/206; 705/30; 705/406

(57) ABSTRACT

The automatic online printing and enveloping system at recipient's post office or home for receiving mail or advertisements via internet is system provides a service which requires the sender to create an email account in order to sign in the email webpage. Then this online system forward email to the recipient or to the nearest post office where it is printed, enveloped, and delivered by postman like other mail. This “ePostal service” is also suitable for email recipients who live in remote location where Internet is not available or for those people who still want to correspond in mail, but hate walking to the post office.

### CROSS-REFERENCE TO RELATED APPLICATION

Not applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to a beneficial system that can help many people to compose and send their e-mails or advertisements via Internet. These e-mails or advertisements were print and enveloped at the addressees' post office or at the addressees' home. The postmen will deliver these e-mails or advertisements to the addressees' home.

### BACKGROUND OF INVENTION

Today the US post service delivers millions of mails or advertisements, from one part of the country to another or between countries. People commonly put the letters, or advertisements and put or print stamps on, or go to the post offices to send them. All these letters have to be sorted at the post offices, arranged into groups according to zip code, and delivered on the next day. The post office of the addressees will do the same thing before sending to the addressees. This way costs postage and waste time.

I have invented a new beneficial, economy type of mail delivery service which offers a speedy delivery of mails. This electronic delivery system comprises of an interactive website, a special printing system, and an automatic enveloping device. The printers and enveloping devices shall be installed at every postal office or home user in the US. These devices shall be connected to the Internet network and after having a registered account in this “Automatic mail printing and enveloping device system”, the senders can access to his file folder. The sender can type some data, information needed such as: address of the sender, address of the receiver, the choice of language, and attached files. The website of this system shall notify the fee and time needed to send these electronic mails. Basing on the unique address assigned to each post office, the delivery system will find out the destination of printing and enveloping devices. The postal offices of the addressees' will print out and envelope these electronic mails or data. The mailmen will deliver to the addressees. Every month the website of this special system will notify the affordable fee to pay for US post offices for these e services. The senders will also receive receipts of their electronic mails. In the case the addressee owns a private automatic printer connecting to this system, he can do this work at home. Because the person who owns this special printer connecting to this system performs the service of “ ” the addressee's post office: he will receive the sum of postage which equal or less to normal post office postage.

### BACKGROUND OF THE INVENTION—OBJECTS AND ADVANTAGES

There are varieties advantages of this “Automatic online mail printing and enveloping device system”.

a/Save Time

This online system is helpful for people who still want to exchange mail in the old way (paper mail) but hate waking to the post office. This online system also saves much time for recipient via post office or who owns an automatic printing device connecting to the website of this system also. The automatic printing and enveloping device will operate upon receiving an incoming email. So there will be no need for stamps, and envelopes.

b/Save Money

In this way we reduce distance to send mail. We only delivery mail from recipient's post office to recipient or mail will be print directly at recipient. The elimination in mail delivery service, envelopes, and postage at post office's recipient can save money this online system can save much more in advertisement service in saving envelopes.

c/Profit for Recipient

If the recipient owns a suitable printing device connecting to this “ePostal service” system, he will get a small profit from payment fee of sender, especially when the recipient receives many mails or advertising mails.

d/The Confirmation of the Legal Status of the Sent Email Content

The content of online mail may be temporarily saved in the system for a period if the sender wants to check the legal status of the mail content.

### SUMMARY

The online system shall automatically print and envelope electronic mail at the destination post office serving for mail sent from remote location via Internet, it composes of an application website where the senders can compose letters or attach other file, pictures, and an automatic printing and enveloping device. This online system is connected with Internet network installing at the addressee's post office. The content of electronic mail sent by the senders shall be forward via Internet to the post office of the senders where they are printed and enveloped. Then the postman will deliver these mails. If the recipient owns a suitable printing device connecting to this system, then the mail printing shall be made directly at the recipient's home. This “ePostal service” is beneficial and economy.

I claim:

1/ The automatic online printing and enveloping system provide an “e Postal service”, a speedy delivery. It includes a online website providing email service which requires the sender create an email account, so the sender can attach file, compose letter, and they send forwarded to the postal address of the recipients where they are printed, enveloped by an online automatic printing and enveloping device before delivery to recipient, furthermore the sender can print out the receipt of mail content if he wants.

2/ The automatic online printing and enveloping device in claim 1 wherein said they operate upon receiving an incoming email, and will also detect parameter such as paper size, and matching envelope type before printing email content and making envelope.

3/ The automatic online printing and enveloping device in claim 1 shows that there is some mail holding tray moving up and down to receive mail from the printer. Mail of the same zip code will be holding the same tray.

4/ The automatic online printing and enveloping device in clam 1 wherein said that it printed mail will be enveloped with transparent plastic envelope so that the receivers can see a part of mail content.

5/ The automatic online printing and enveloping system in clam 1 wherein said the way the recipient can get profit-money from senders by using The system of automatic printing and enveloping is if the recipient owns an suitable online printing device connecting to this “epostal service” system to print mails or advertisements from senders, the sender open an account on “ePostal service” to pay fee to send mail or advertisements to “epostal service” then the “epostal service” will pay a part of this fee to the recipient in an account of the recipient on the “ePostal service” also.

6/ The automatic online printing and enveloping system in clam 1 wherein said the way send mail or advertisements from email convert to mail or advertisements is printed automatic on normal paper by The automatic online printing and enveloping system.
